(19) United States
(12) Patent Application Publication
(10) Pub. No.: US 2006/0215995 A1
(43) Pub. Date: Sep. 28, 2006

(54) Information recording device information recording method information reproduction device information reproduction method information recording program information reproduction program information recording medium and recording medium

(76) Inventor: Kenichiro Tada, Saitama (JP)

Correspondence Address: DRINKER BIDDLE & REATH (DC), 1500 K STREET, N.W., SUITE 1100, WASHINGTON, DC, 20005-1209, US

(21) Appl. No.: 10/568,387

(22) PCT Filed: Sep. 21, 2004
(86) PCT No.: PCT/JP04/13742

§ 371 Date: Feb. 15, 2006

(30) Foreign Application Priority Data
Oct. 31, 2003 (JP) 2003-373097

(51) Int. Cl. H04N 7/00

(52) U.S. Cl. 386/95

(57) ABSTRACT

This invention provides a information-recording medium that makes it possible to execute smooth processing without having to continuously calculate when the applicable changing point of the encoding key. AV stream information 3 in which encoding information is recorded that is obtained by encoding an MPEG2-standard transport stream comprising an application GOP while changing the encoding key at the boundary of a CBC block different from that application GOP, and a key-change flag 11 in which key-change information that indicates whether or not a plurality of encoding keys is necessary for encoding I pictures contained in the application GOP in the encoded information are recorded on a hard disc 1.

### FIELD OF THE INVENTION

This invention relates to an information-recording apparatus and information-recording method, information-reproduction apparatus and information-reproduction method, information-recording program, information-reproduction program, information-recording medium and recording medium, and more particularly to: an information-recording apparatus and information-recording method of encoding recording information that contains at least still images of moving-image information for a movie or the like, and recording that recording information onto an information-recording medium; an information-reproduction apparatus and information-reproduction method of reproducing the encoded and recorded recording information from an information-recording medium; an information-recording program used in recording information; an information-reproduction program used in reproducing information; an information-recording medium on which recording information is recorded, and a recording medium on which the information-recording program or information-reproduction program is recorded.

### BACKGROUND ART

Conventionally, the encoding apparatus such as disclosed in patent document 1 below has been used as an apparatus that receives a broadcast signal, then encodes and records the obtained and digitized moving-image information in block units. This encoding apparatus changes the encoding key used in encoding for each block, and first, in a block-division unit, it divides the input moving-image information into a first block and second block, then a first encoding unit encodes the first block using second intermediate data, and outputs that encoded result as first encoded data.

Next, a second encoding unit uses first intermediate data to encode the second block, and outputs that encoded result as second encoded data.

After that, a block-combining unit combines the output first encoded data and second encoded data, and outputs the result as encoded information, which is the encoded original moving-image information. (Reference: Japanese Patent Laying Open of Application No. 2000-261423)

However, when considering the case of using the invention disclosed in the aforementioned Patent Document 1 to reproduce encoded and recorded digital data, such as an MPEG (Moving Picture Expert Group) transport stream (hereafter referred to as TS (Transport Stream)), due to differences in the minimum access unit GOP (Group of Pictures) in the aforementioned MPEG transport stream and the information unit encoded using the same encoding key, when reproducing, for example, I (intra-coded) pictures in the same encoded GOP, if the MPEG transport stream is recorded in a format that uses a plurality of different decoding keys, a calculation process for calculating the applicable range for each encoding key in the I picture must be executed for a plurality of encoding keys at the same time as the reproduction process, which could result in hindering a smooth reproduction process, particularly when performing fast-forward reproduction or when searching for the reproduction position.

In other words, when performing encoding using the invention disclosed in the aforementioned Patent Document 1, the applicable range for that encoding key is often managed using the number of CBC blocks, which is the encoding unit used when encoding in the so-called CBC (Cipher Block Chain) method, and the recording format for the MPEG transport stream data is managed based on the amount of information (number of bytes or number of packets), and as a result, up until now there has been no information about the relationship between the range for which the aforementioned encoding key is applied and the data of the aforementioned MPEG transport stream.

Therefore, in order to calculate the applicable range of the encoding key (or in other words, the applicable point of change), it is necessary to calculate the applicable range in detail based on management information that is contained in that management file, while at the same time reading the aforementioned MPEG transport stream data, and together with being the cause of trouble such as processing delays when performing special reproduction, such as when performing fast-forward reproduction, or searching for the reproduction position mentioned above, there are also problems in that from a hardware aspect the processing load becomes large, and the memory capacity of the memory used when performing reproduction must be increased.

### DISCLOSURE OF THE INVENTION

Problems to be Solved by the Invention

Taking these problems into consideration, it is the object of this invention to provide an information-recording apparatus and information-recording method for recording information, an information-reproduction apparatus and information-reproduction method for reproducing that recorded information, an information-recording program used for recording the information, an information-reproduction program used for reproducing the information, an information recording medium on which the information is recorded, and a recording medium on which the information-recording program and information-reproduction program are recorded that make it possible to perform smooth reproduction and recording processing without having to perform detailed calculation of the applicable range (applicable point of change) for the encoding key.

Means for Solving the Problem

The above object of the present invention can be achieved by an information-recording medium of the present invention. The information-recording medium is provided with: an encoded-information-recording area in which encoded information, which is obtained by encoding recording information containing at least one unit of image information while changing the encoding key at the boundary between the image-information unit and a different encoding unit, is recorded; and a key-change-information-recording area in which key-change information, which indicates whether or not a plurality of encoding keys is necessary for encoding still-image information contained in said image-information unit in said encoded information, is recorded.

According to the present invention, AV (Audio Visual) stream information, which is a transport stream comprising an application GOP according to the MPEG2 standards that is encoded and obtained as encoded information by changing the encoding key at the boundaries between CBC blocks that are different than that application GOP, and a key-change flag, which contains key-change information that indicates whether or not a plurality of encoding keys is necessary for decoding an I picture contained in an application GOP of the aforementioned encoded information, so it is not necessary to continuously calculate the applicable point at which the key changes, making it possible to execute processing smoothly, as well as making it possible to reduce the hardware load and the capacity of the memory.

In one aspect of the present invention can be achieved by the information-recording medium of the present invention. The information-recording medium is, wherein there is a said key-change-information-recording area for each said image unit.

According to the present invention, there is a key-change flag located in each application GOP, so it is not necessary to continuously calculate the applicable point when the key changes, making it possible to execute processing smoothly, as well as making it possible to reduce the hardware load and the capacity of the memory.

In another aspect of the present invention can be achieved by the information-recording medium of the present invention. The information-recording medium is, wherein said still-image information is encoded image information for a frame.

According to the present invention, an I picture is decoded as still-image information, so it is not necessary to continuously calculate the applicable point when the key changes, making it possible to execute processing smoothly, as well as making it possible to reduce the hardware load and the capacity of the memory.

In further aspect of the present invention can be achieved by the information-recording medium of the present invention. The information-recording medium is, wherein said image-information unit comprises an encoded-image-information group that contains at least said encoded-information for a frame.

In further aspect of the present invention can be achieved by the information-recording medium of the present invention. The information-recording medium is, wherein said image-information unit comprises a MPEG (Moving Picture Experts Group)-2TS (Transport Stream) sequence header, and the GOP (Group of Pictures) that is sent after said sequence header.

According to the present invention, the application GOP comprises a sequence header for the MPEG2-standard transport stream, and the GOP that is sent after that sequence header, so it is not necessary to continuously calculate the applicable point when the key changes, making it possible to execute processing smoothly, as well as making it possible to reduce the hardware load and the capacity of the memory.

The above object of the present invention can be achieved by an information-recording apparatus of the present invention. The information-recording apparatus is provided with: a first generation device which generates encoded information, which is obtained by encoding recording information containing at least one unit of image information while changing the encoding key at the boundary between the image-information unit and a different encoding unit; and a second generation device which records key-change information, which indicates whether or not a plurality of encoding keys is necessary for encoding still-image information contained in said image-information unit in said encoded information.

According to the present invention, an MPEG2-standard transport stream comprising application GOP in which the encoding key changes at the boundary of a CBC block that is different than the application GOP, and key-change information that indicates whether or not a plurality of encoding keys is necessary for decoding an I picture contained in the application GOP in the encoded information, so it is not necessary to continuously calculate the applicable point when the key changes, making it possible to execute processing smoothly, as well as making it possible to reduce the hardware load and the capacity of the memory.

In one aspect of the present invention can be achieved by the information-recording medium of the present invention. The information-recording apparatus of the present invention is, wherein there is a said key-change-information-recording area for each said image unit.

According to the present invention, there is a key-change flag for each application GOP, so it is not necessary to continuously calculate the applicable point when the key changes, making it possible to execute processing smoothly, as well as making it possible to reduce the hardware load and the capacity of the memory.

In another aspect of the present invention can be achieved by an information-recording apparatus of the present invention. The information-recording apparatus of the present invention is, wherein said still-image information is encoded image information for a frame.

According to the present invention, the I picture is decoded as still-image information, so it is not necessary to continuously calculate the applicable point when the key changes, making it possible to execute processing smoothly, as well as making it possible to reduce the hardware load and the capacity of the memory.

In further aspect of the present invention can be achieved by an information-recording apparatus of the present invention. The information-recording apparatus of the present invention is, wherein said image-information unit comprises a MPEG-2TS sequence header, and the GOP (Group of Pictures) that is sent after said sequence header.

According to the present invention, the application GOP comprises a sequence header for the MPEG2-standard transport stream, and the GOP that is sent after that sequence header, so it is not necessary to continuously calculate the applicable point when the key changes, making it possible to execute processing smoothly, as well as making it possible to reduce the hardware load and the capacity of the memory.

The above object of the present invention can be achieved by an information-reproduction apparatus of the present invention. The information-reproduction apparatus that reproduces said recorded information from said information-recording medium on which an encoded-information-recording area in which encoded information, which is obtained by encoding recording information containing at least one unit of image information while changing the encoding key at the boundary between the image-information unit and a different encoding unit; and a key-change-information-recording area in which key-change information, which indicates whether or not a plurality of encoding keys is necessary for encoding still-image information contained in said image-information unit in said encoded information, are recorded; and is provided with: an encoded-information-detection device which detects said encoded information from said information-recording medium; a key-change-information-detection device which detects said key-change information from said information-recording medium; a decoding device which decodes said encoded information based on detected said key-change information; and a reproduction device which reproduces the decoded said encoded information.

According to the present invention, a reading unit that detects and reads encoded information from a Hard Disc, a decoding unit that decodes the encoded information based on detected key-change information, and a reading unit that reproduces the decoded encoded information, so it is not necessary to continuously calculate the applicable point when the key changes, making it possible to execute processing smoothly, as well as making it possible to reduce the hardware load.

In one aspect of the present invention can be achieved by an information-reproduction apparatus of the present invention. The information-reproduction apparatus of the present information is, wherein there is a said key-change-information-recording area for each said image unit.

According to the present information, there is a key-change flag 11 for each application GOP, so it is not necessary to continuously calculate the applicable point when the key changes, making it possible to execute processing smoothly, as well as making it possible to reduce the hardware load and the capacity of the memory.

In another aspect of the present invention can be achieved by an information-reproduction apparatus of the present invention. The information-reproduction apparatus of the present invention is, wherein said still-image information is encoded image information for a frame.

According to the present information, the I picture is decoded as still-image information, so it is not necessary to continuously calculate the applicable point when the key changes, making it possible to execute processing smoothly, as well as making it possible to reduce the hardware load and the capacity of the memory.

In further aspect of the present invention can be achieved by an information-reproduction apparatus of the present invention. The information-reproduction apparatus of the present invention is, wherein said image-information unit comprises an encoded-image-information group that contains at least said encoded-information for a frame.

According to the present invention, the application GOP comprises a sequence header for the MPEG2-standard transport stream, and the GOP that is sent after that sequence header, so it is not necessary to continuously calculate the applicable point when the key changes, making it possible to execute processing smoothly, as well as making it possible to reduce the hardware load and the capacity of the memory.

### BRIEF DESCRIPTION OF THE DRAWINGS

FIG. 1 is a drawing explaining the stream information in the recording formation of an embodiment of the invention.

FIG. 2 is a drawing explaining the encoded information in the recording formation of an embodiment of the invention.

FIG. 3 is a block diagram showing the overall construction of the information-recording apparatus of an embodiment of the invention.

FIG. 4 is a block diagram showing the internal construction of the recording module.

FIG. 5 is a flowchart showing the recording process of an embodiment of the invention.

FIG. 6 is a flowchart showing the encoding-auxiliary-operation process of an embodiment of the invention.

FIG. 7 is a drawing explaining the format of the stream information that is developed in RAM in an embodiment of the invention.

FIG. 8 is a drawing explaining the format of the encoded information that is developed in RAM in an embodiment of the invention.

FIG. 9 is a flowchart showing the recording-end process of an embodiment of this invention.

FIG. 10 is a block diagram showing the information-reproduction apparatus of an embodiment of the invention.

FIG. 11 is a flowchart showing the reproduction process of an embodiment of the invention.

FIG. 12 is a flowchart showing the search process of an embodiment of the invention.

FIG. 13 is a flowchart showing a special reproduction process of an embodiment of the invention.

FIG. 14 is a flowchart showing another special reproduction process of an embodiment of the invention.

FIGS. 15A to 15D are drawings explaining the expanded format of the key-change flag of an embodiment of this invention, where FIG. 15A is a drawing showing a first example, FIG. 15B is a drawings showing a second example, FIG. 15C is a drawing showing a third example, and FIG. 15D is a drawing showing a fourth example.

### EXPLANATION OF LETTERS OR NUMERALS

1 HD
2 UNIT INFORMATION
3 AV STREAM INFORMATION
4 ENCODED INFORMATION
5 STREAM INFORMATION
6 UNIT SIZE
7 NUMBER OF POINTER TABLES
8 POINTER TABLE
9 GOP SIZE
10 FIRST REFERENCE IMAGE SIZE
11 KEY-CHANGE FLAG
12 APPLICABLE RANGE INFORMATION
13 APPLICABLE START CBC NUMBER
14 NUMBER OF APPLICABLE CBC
15 INFORMATION RECORDING APPARATUS
21 DEMULTIPLEXER
22 AUDIO/VIDEO DATA DECODER
24 RECORDING MODULE
25 CPU
26 MEMORY
31 INFORMATION-SUPPLY UNIT
32 ENCODING UNIT
40 INFORMATION REPRODUCTION APPARATUS
41 INFORMATION-OUTPUT UNIT
42 DECODING UNIT
43 READING UNIT

### BEST MODE FOR CARRYING OUT THE INVENTION

The preferred embodiment of the present invention will be explained below with reference to the drawings.

The preferred embodiment explained below is an embodiment of the case in which the present invention is applied to an information-recording apparatus that is capable of recording AV (Audio Visual) information, which is distributed in a digital broadcast such as a BS (Broadcasting Satellite) digital broadcast and then encoded according to CBC format, on to an information-recording medium such as a hard disc, and an information-reproduction apparatus that is capable of reproducing the aforementioned AV information. In the explanation below, the information-recording apparatus and information-reproduction apparatus, which are stored in one frame and use the same hard disc 1 (to be described later) in common, will be explained separately.

Also, in the explanation below, the aforementioned AV information is taken to be information that is broadcast according to the transport stream standards of the well known MPEG2 standards, which are standards related to compression technology of moving images.

Furthermore, in the information-recording process and information-reproduction process explained below, standards applied to CBC blocks as the encoding unit, standards applied to physical access units for hard discs and recording media, and standards related to matching the access starting position on the information-recording medium in the aforementioned access units with the starting position on the information-recording medium in the aforementioned CBC blocks are basically adhered to as the very minimum.

More specifically with regards to the standards mentioned above, access of the contents contained in recorded AV information is performed from the start of the sector in the hard disc that contains that access location.

Also, when the amount of information in physical access units on a hard disc or the like is 512 bytes, and logical access is only performed for multiples of that, for example 6,144 (12×) bytes, the amount of information in CBC blocks is made to match the amount of information in access units. In other words, the access position on the hard disc or the like is made to match the starting position of CBC blocks.

(I) Recording Format

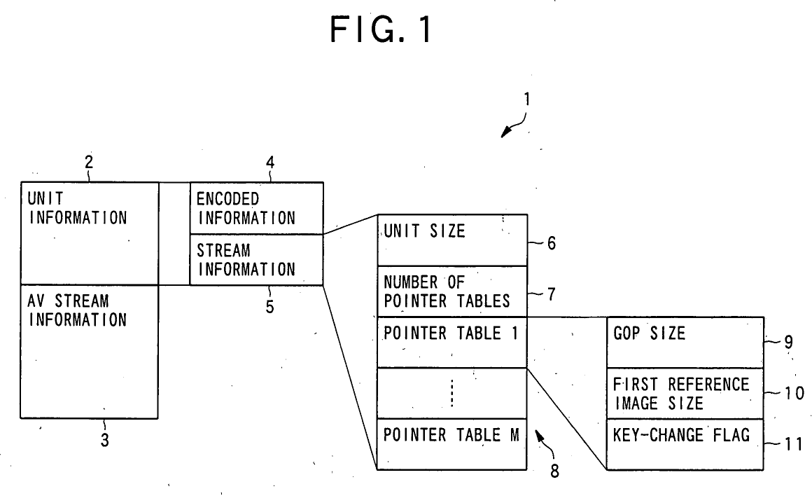

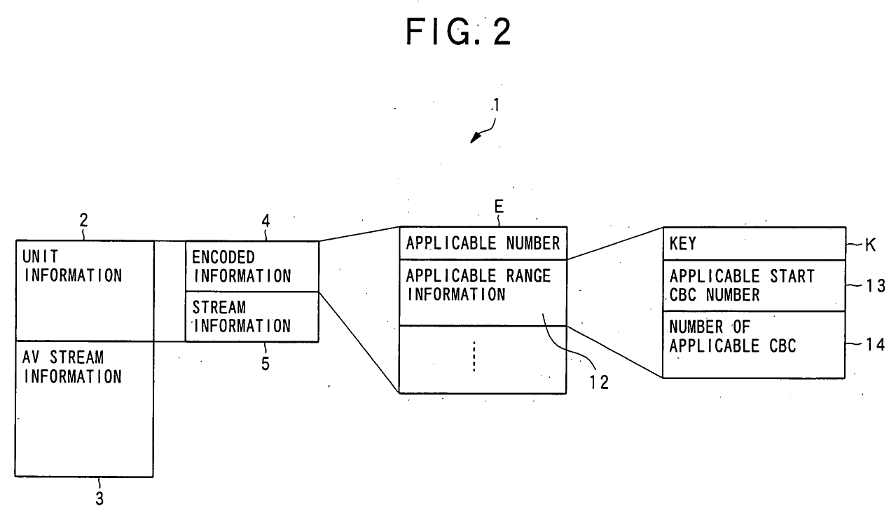

First, before explaining in detail about the information-recording apparatus of this embodiment, FIG. 1 and FIG. 2 will be used to give an overview of the logical recording format used when the information-recording apparatus records AV information on a hard disc or the like.

The recording format shown in FIG. 1 and FIG. 2 hierarchically and schematically shows the recording format after AV information has been recorded on the hard disc based on the recording format.

Also, the recording format shown in FIG. 1 and FIG. 2 is logical recording format that is used in this embodiment when recording AV information to a hard disc, and the physical recording format that is used when recording is a well-known physical format as is that is used by the hard disc.

First, a summary of various concepts that are used for the recording format in order to efficiently manage the contents and recorded form of the recorded AV information will be given.

First, in the recording format below, the concept of units is used when handling recorded AV information. In other words, that unit is one unit of AV information that is recorded continuously in time on the hard disc. For example, when AV information is broadcast in a BS digital broadcast, one event in that BS digital broadcast is defined as one unit.

Second, in the recording format below, the concept of a directory is used in which in a BS digital broadcast, the packet IDs of packets that store the video information contained in the transport stream are the same according to intentions on the side of the broadcaster. In other words, the directory identifies all or part of one unit, and expresses it as a section having the same packet ID.

Third, in the recording format below, the concept of an application GOP is used, and it indicates divided-section information in a unit that delivers the GOP mentioned in the MPEG2 standards. This application GOP comprises the MPEG-TS sequence header and the GOP data that is sent after that sequence header, and it forms the image-information unit of this invention. Also, the MPEG-TS, which comprises the application GOP, forms the recording information of this invention. Furthermore, an I picture forms encoded image information in a frame, which is the still-image information of this invention, and the GOP forms the encoded image information group of this invention.

Next, the logical recording format of this embodiment will be explained based on the various concepts described above.

As shown in FIG. 1, after the necessary AV information has been recorded, the unit information 2, which is management information corresponding to each of the aforementioned units, and AV stream information 3, which is the actual broadcast AV information as is that is recorded on the hard disc 1, are recorded on the hard disc 1. This AV stream 3 forms the encoded information recording area of this invention.

Also, the aforementioned unit information 2 comprises encoded information 4 and stream information 5, which is management information for managing the aforementioned AV stream information 3.

Here, the stream information 5 comprises: the unit size 6 (4 bytes) that indicates the number of TS packets contained in a unit, pointer-table number 7 (4 bytes) that indicates the number of application GOP contained in a unit, and pointer tables (8) (contains just same number as there are application GOP (m number in FIG. 1)).

Next, FIG. 1 and FIG. 2 will be used to explain in detail the construction of the aforementioned pointer table 8.

As shown in FIG. 1, one pointer table 8 comprises: the GOP size 9 (4 bytes) that indicates the number of packets contained in the corresponding GOP, a first reference image size 10 (2 bytes) that indicates the number of packets starting from the first packet of the corresponding GOP up to the packet that contains the first I picture in the application GOP; and a key-change flag 11 (1 byte) that indicates that it is necessary to change the encoding key when decoding the area where the aforementioned first I picture is recorded. There is a key-change flag 11 for each application GOP, and it forms the key-change-information-recording area of this invention.

Here, the key-change flag 11 is a flag that indicates that a plurality of encoding keys is necessary for decoding a GOP I picture, and its value is ‘1’ when a plurality of encoding keys is necessary for decoding, and its value is ‘0’ when the I picture can be decoded with only one encoding key, or when no encoding key is necessary for decoding. In other words, the key-change flag 11 contains key-change information indicating whether or not a plurality of keys is necessary for decoding I pictures contained in an application GOP in the encoded and recorded MPEG-TS.

On the other hand, as shown in FIG. 2, the encoded information 4 is information related to encoding the original unit and is necessary for decoding and reproducing the unit, and it comprises: the applicable number E that indicates the number of applicable ranges for an encoding key for decoding and reproducing a unit, and applicable-range information 12 (includes just the same number as the number of applicable ranges for each encoding key), which is information related to each applicable range.

Also, each item of applicable range information comprises: an encoding key K that is used for actually decoding that applicable range, a range starting CBC number 13 that indicates the number of CBC blocks from the start of the AV stream information 3, and the applicable number of CBC 14 that indicates the size of each applicable range by the number of CBC blocks.

(II) Information-Recording Apparatus

Next, the construction and operation of the information-recording apparatus that records AV information onto a hard disc using the recording format described above will be explained.

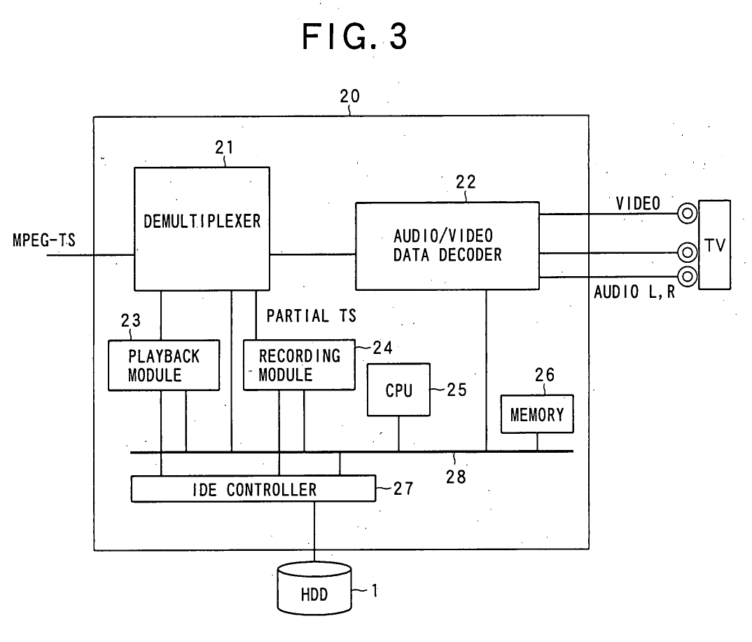

First, FIG. 3 will be used to explain the overall construction and main operation of the information-recording apparatus. In FIG. 3, the CPU 25 controls all of the major components in the information-recording apparatus 20, and for simplification, only the control part related to this embodiment is shown.

As shown in FIG. 3, the information-recording apparatus 20 of this embodiment, is directly connected to an external television apparatus TV, and is connected to a digital-broadcast-receiving circuit (not shown in the figure) that receives a digital broadcast from an antenna.

Also, the information-recording apparatus 20 comprises: a demultiplexer 21, AV data decoder 22, playback module 23, recording module 24, first-generation unit, second-generation unit and CPU 25, memory 26, IDE controller 27, bus 28, and hard disc 1 (hereafter referred to as HD) as the information-recording medium.

Next the basic operation will be explained.

First, the demultiplexer 21 extracts just the required packets from the MPEG-TS that is input from the aforementioned digital-broadcast-receiving circuit. More specifically, by specifying the packet ID carrying a video signal to be decoded from a digital broadcast that is sent in MPEG-TS format, the demultiplexer 21 lets the packets for that video signal pass. Similarly, when another packet ID that is carrying data to be used by the CPU 25 is set, the demultiplexer 21 has a function to extract the packets indicated by that packet ID. In this way, only the necessary packets are extracted from the information that is sent in MPEG-TS format, and it is called a partial TS.

Next, the AV data decoder has a function that decodes the audio and video information that is carried by the packet ID specified by the CPU 25 from the partial TS that was obtained by the demultiplexer 21, and also extracts any additional data, and outputs these as video data and audio data.

The playback module 23 uses the IDE controller 27 to provide the data of the partial TS recorded on the HD 1 to the demultiplexer 21.

On the other hand, while encoding the partial TS, the recording module 24 uses the IDE controller 27 to record that encoded stream to the HD 1.

At the same time as these processes, the CPU 25 controls all of the components. At this time, when recording information, the volatile memory 26 creates information in the memory corresponding to the unit information 2 on the HD 1, and temporarily stores that unit information 2 when reproducing information.

Also, the IDE controller 27 issues an ATA (AT Attachment) command, and exchanges data with the HD 1.

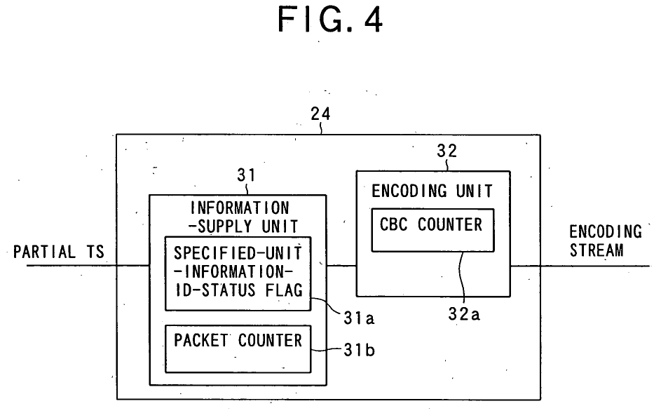

Next, the internal construction of the recording module 24 will be explained using FIG. 4.

As shown in FIG. 4, the recording module 24 comprises an information-supply unit 31 that acquires a partial TS, and an encoding unit 32 that outputs an encoded stream, and furthermore, the information-supply unit 31 supplies information obtained from the outside to the following encoding unit 32, and at that time performs processing such as buffering.

Also, based on a control signal from the CPU 25, the information-supply unit 31 has a function for starting or stopping those operations. Furthermore, a specified-unit-information-ID-status flag 31a, which maintains the status of whether or not to identify specified unit information (more specifically, the state where the state of an I picture or sequence header code (SHC) or GOP header or the like is detected, the state where the start of a different picture is detected after detection, etc.) is set in the information-supply unit 31, and that specified-unit-information-ID-status flag 31a can be referenced from other components. When that happens, the information-supply unit 31 continues the operation of identifying specified unit information, causing the state to always change. Also, the information-supply unit 31 further has a packet counter 31b, that counts the input packets and maintains data indicating that count value.

On the other hand, the encoding unit 32 has a CBC counter 32a that counts the number of CBC blocks, and based on a control signal from the CPU 25 it generates an encoding key, then encodes the information obtained from the information-supply unit 31 for each fixed-length code block and outputs that information to the following unit.

When recording ends, the CPU 25 performs an operation to write the information in the memory 26 onto the HD 1 as unit information 2. By doing this, logical information is created on the HD 1.

(II-A) Recording Process

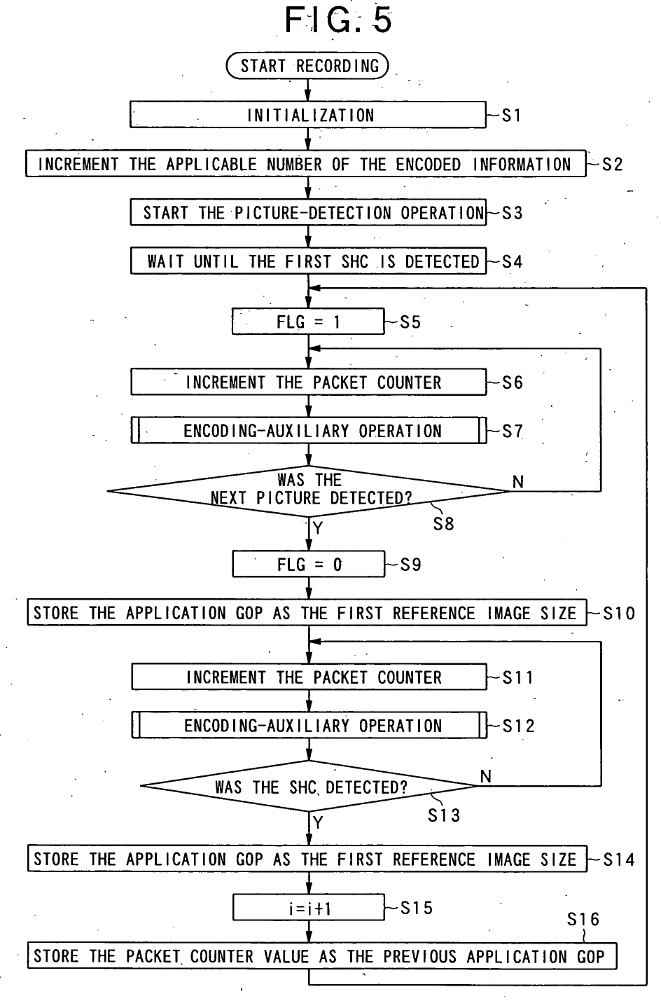

Next, the recording process by the information-recording apparatus 20 centering on the CPU 25 will be explained using FIG. 5 as a reference.

The CPU 25 executes the initialization process in step S1. In other words, in the initialization process, it performs a process of setting the value of the applicable number E for encoding information 4 to ‘0’, the value of the packet counter 31b to ‘0’, the value of the previous application GOP position to ‘0’, the value of the CBC counter 32a to ‘0’, the value of the specified-unit-information-ID-status flag 31a to ‘0’, the value of the application GOP index to ‘0’ and the value of the applicable starting CBC number of the applicable range information 12 to ‘0’.

Next, the encoding unit 32 generates an encoding key and waits, then sets the key K for the applicable-range information 12 and increments the applicable number E of the encoding information 4 (step S2), after which the information-supply unit 31 starts the operation for detecting pictures, and starts input of the partial TS (step S3).

In step S4, the CPU 25 waits until the information-supply unit 31 detects the first sequence header code, and when the first sequence header code is detected, it sets the value of the specified-unit-information-ID-status flag 31a to [1] (step S5).

In step S6, the information-supply unit 31 inputs one packet, and after the packet counter 31b has been incremented, the CPU executes the encoding-auxiliary operation (step S7). The encoding-auxiliary operation will be described later.

In step S8, the CPU 25 determines whether or not the information-supply unit 31 has detected the next picture, and when the next picture has been detected (step S8: YES), the CPU 25 advances to step S9 and sets the value of the specified-unit-information-ID-status flag 31a to [0]. However, when the next picture has not been detected (step S8: NO), the CPU 25 returns to step S6 and repeats the processing of step S6 and step S7 until the next picture is detected.

Next, in step S10, the value of the previous application GOP position is subtracted from the value of the packet counter 31b, and the result is stored as the first reference image size 10 in the corresponding application GOP, then in step S11, as was done in step S6 and step S7, the CPU 25 inputs a packet, and after incrementing the value of the packet counter 31b, executes the aforementioned encoding-auxiliary operation again (step S12).

Next, in step S13, the CPU 25 determines Whether or not sequence header code has been detected, and when sequence header code has been detected (step S13: YES), it advances to step S14, then subtracts the value of the previous application GOP position from the value of the packet counter 31b and stores the result as the GOP size 9 in the corresponding application GOP. On the other hand, when sequence header code is not detected (step S13: NO), the CPU 25 returns to step S11 and repeats the processing of step S11 and step S12 until sequence header code is detected.

By doing this, in step S15, after the parameter i that indicates the application GOP number has been incremented, the CPU 25 stores the value of the packet counter 31b as the value of the previous application GOP position (step S16). Also, the CPU 25 returns to step S5 and repeats processing starting from step S5.

(II-B) Encoding-Auxiliary-Operation Process

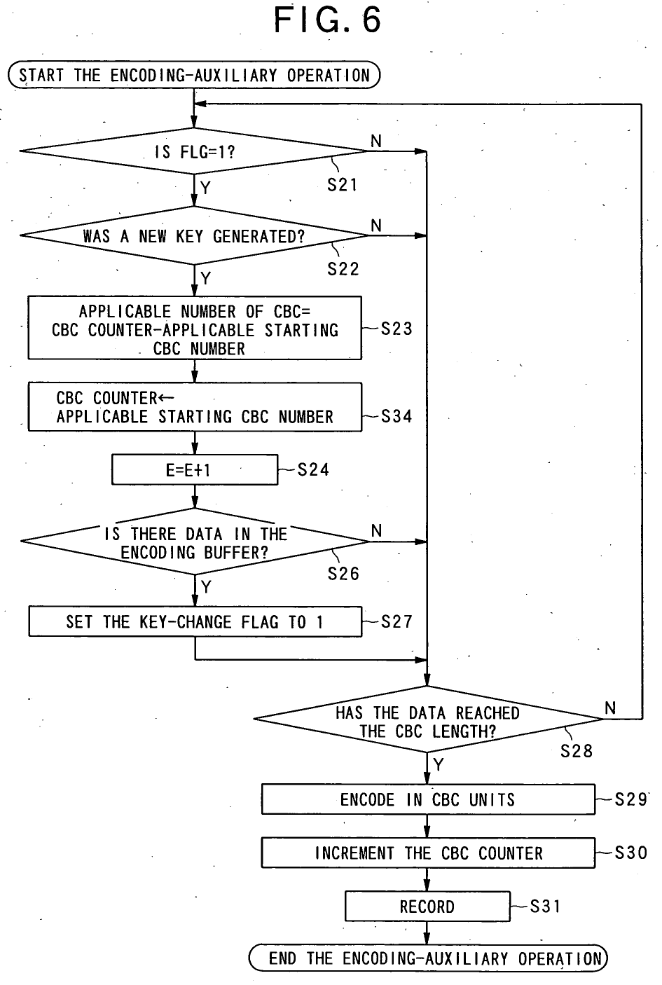

Next, the encoding-auxiliary-operation process by the CPU 25 will be explained in detail using FIG. 6.

In the encoding-auxiliary-operation process, the CPU 25 first determines in step S21 whether or not the specified-unit-information-ID-status flag 31a is ‘1’, and when the value of the specified-unit-information-ID-status flag 31a is ‘1’ (steps S21: YES), the CPU 25 then determines in step S22 whether or not a new encoding key has been created. When a new encoding key has been created (step S22: YES), the CPU 25 sets the value of the applicable number of CBC 14 in the previous (E-first) applicable range information 12 to be the value of the value of the applicable starting CBC number 13 in the previous (E-first) applicable range 12 subtracted from the value of the CBC counter 32a at that time (step S23), and sets the value of the applicable starting CBC number 13 in the Eth applicable range information 12 to be the CBC counter 32a at that time (step S24), and then increments the applicable number E (step S25).

In step S26, the CPU 25 determines whether or not there is data in the encoding buffer (not shown in the figures), and when there is data (step S26: YES), then in step S27 it sets the value of the key-change flag 11 for the ith application GOP to be ‘1’, after which it advances to step. S28.

In step S21, when the value of the specified-unit-information-ID-status flag 31a is not ‘1’ (step S21: NO), in step S22, when a new encoding key has not been created (step S22: NO), or in step S26, when there is no data in the encoding buffer (step S26: NO), the CPU 25 advances directly to step S28.

Also, in step S28, the CPU 25 determines whether or not the amount of information of the data in the encoding buffer has reached the amount of information for one CBC block, and when the amount of information of that data has reached the amount of information for one CBC block (step S28: YES), then in step S29, after encoding using the corresponding CBC unit, the CPU 25 increments the CBC counter 32a and records the encoded information (steps S30, S31).

In step S28, when the amount of stored data has not reached the amount of information for one CBC block (step S28: NO), then the CPU 25 returns to step S21. The CPU 25 ends the encoding-auxiliary operation by executing this series of processes.

(II-C) Recording Format Developed in RAM

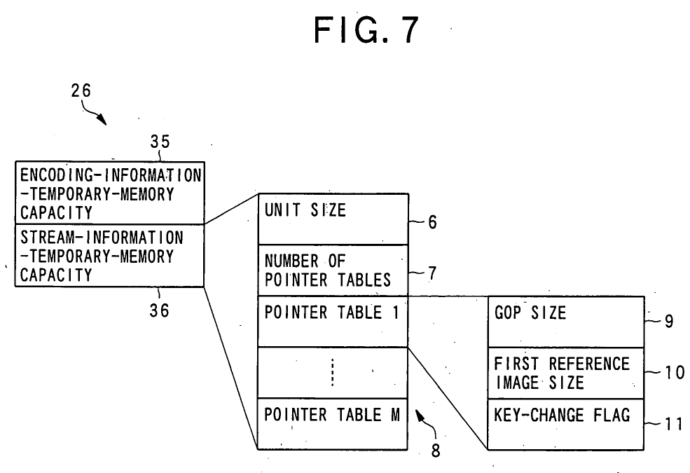

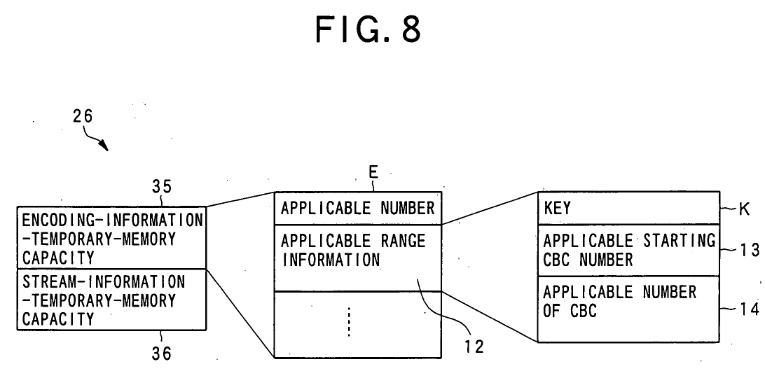

Next, in this embodiment, the memory 26 shown in FIG. 3 is RAM, and the stream information 5 developed in this memory 26 will be explained using FIG. 7, and the encoding information 4 developed in this memory 26 will be explained using FIG. 8. In FIG. 7 and FIG. 8, parts that are the same as those shown in FIG. 1 and FIG. 2 will be given the same reference numbers, and an explanation of those parts will be omitted.

In this embodiment, when executing the recording process, the necessary unit information 2 is developed and created in the memory 26.

In other words, as shown in FIG. 7, the stream information 5 that is developed in the stream-information-temporary-memory area 36 set inside the memory 26, as in FIG. 1, comprises: the unit size 6 that indicates the number of TS packets contained in a unit, the pointer-table number 7 that indicates the number of application GOP contained in a unit, and the pointer table 8 that indicates the application GOP information.

Also, similarly, as shown in FIG. 8, the encoding information developed in the encoding-information-temporary-memory area 35 set inside the memory 26, as in FIG. 2, comprises: the applicable number E, and applicable range information 12 related to each applicable range.

(II-D) Recording End Process

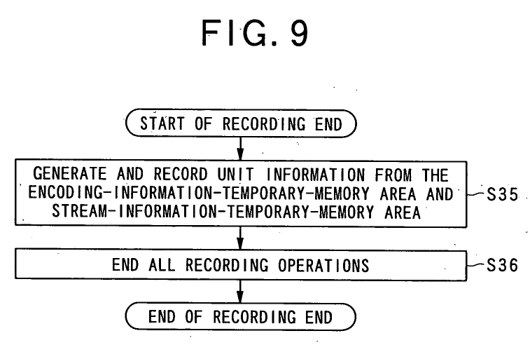

Next, the recording end process that is executed when ending the series of recording processes for recording to the HD1 will be explained using FIG. 9 and centering on the CPU 25.

In the recording end process, first, the CPU 25 reads the encoding information 4 from the encoding-information-temporary-memory area 35 and reads the stream information 5 from the stream-information-temporary-memory area 36 and records them as unit information 2 (step S35), and then ends all recording operations (step S36).

(III) Information Reproduction Apparatus

Next, the construction and operation of the information-reproduction apparatus that reproduces AV stream information that is recording on a HD 1 using the recording format described above will be explained.

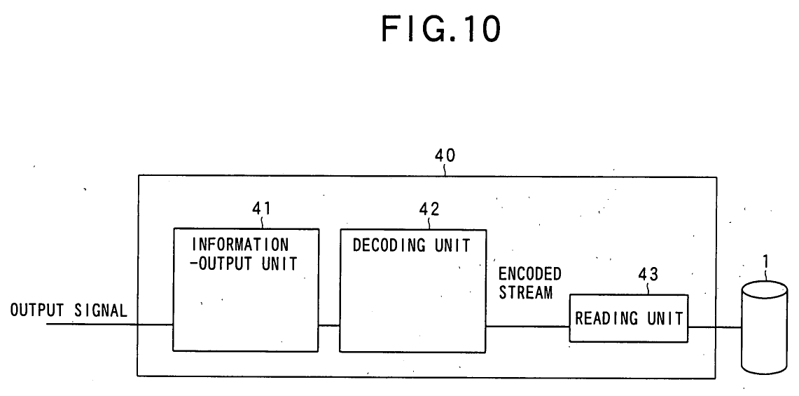

First, FIG. 10 will be used to explain the overall construction and basic operation of the information-reproduction apparatus.

As shown in FIG. 10, the information-reproduction apparatus 40 of this embodiment comprises: an information-output unit 41; a decoding unit 42 that functions as a key-change-information-detection unit, decoding unit and search unit; and a reading unit 43 that functions as a encoded-information-detection unit and reproduction unit. The decoding unit 42 searches the key K required for decoding an I picture when the detected key-change information indicates that two or more keys K are required in the process of decoding the encoded I picture. Also, the reading unit 43 outputs the encoded information obtained from the HD 1 (encoded partial TS) to the decoding unit 42.

By doing this, the decoding unit 42 decodes the partial TS obtained from the reading unit 43 according to control from the CPU (not shown in the figure) for each CBC block, and outputs the decoded partial TS to the information-output unit 41.

Also, the information-output unit 41 supplies the decoded partial TS that was obtained from the decoding unit 42 to the outside while executing a preset buffer process. Moreover, the information-output unit 41 has the function of starting or stopping these operations according to control from the CPU (not shown in the figure).

(III-A) Normal Reproduction Process

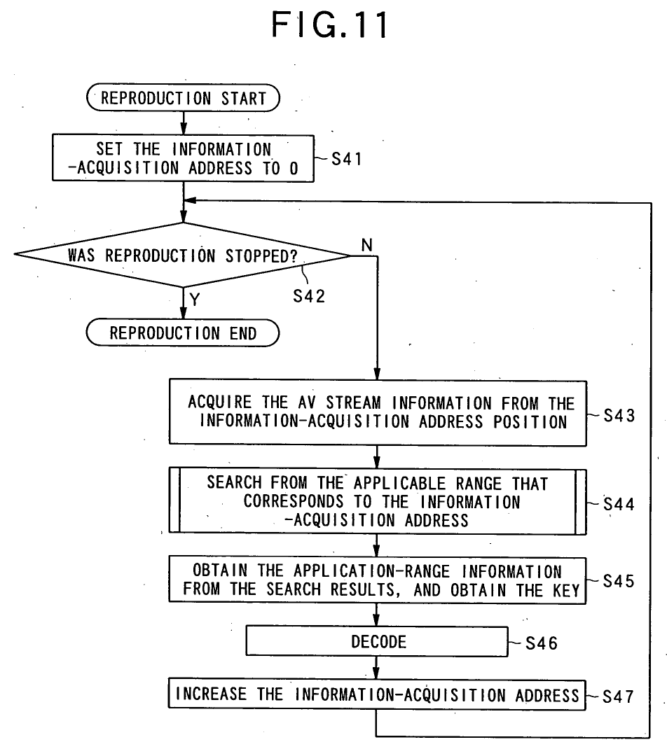

Next, the normal reproduction process by the CPU (not shown in the figure) will be explained using FIG. 11. The reproduction process is a process of normally reproducing AV stream information that is recorded on the HD 1 from the start.

First, in step S41, after setting the information-acquisition address to ‘0’, the CPU determines whether or not a control has been executed from the control unit (not shown in the figure) to stop the reproduction process (step S42), and when that control has been executed (step S42: YES), the reproduction process ends.

On the other hand, when the control to stop the reproduction process has not been executed (step S42: NO), the CPU advances to step S43 and acquires the AV stream information 3 starting from the position of the information-acquisition address.

Next, in step S44, the CPU searches the applicable range of the CBC block that corresponds to the information-acquisition address, then acquires the applicable-range information 12 from the search results and obtains the key K (step S45). The processing in step S44 will be described later.

Also, in step S46, after using the key K to decode the partial TS obtained from the reading unit 43 by the decoding unit 42 for each fixed-length CBC block, the CPU increments the information-acquisition address (step S47). The process from step S43 to step S47 is repeated until reproduction is stopped in step S42.

In order to search for the applicable range that corresponds to the information-acquisition address, an operation to sequentially reference the applicable-range information 12 in the encoding information 4 shown in FIG. 2 occurs. However, in the case of normal reproduction shown in FIG. 11, the information-acquisition address can be taken to be a fixed multiple of the amount of information of a CBC block, and when it is a fixed multiple of the amount of information of a CBC block, it is easy to search the applicable range of the CBC block.

(III-B) Applicable Range Search Process

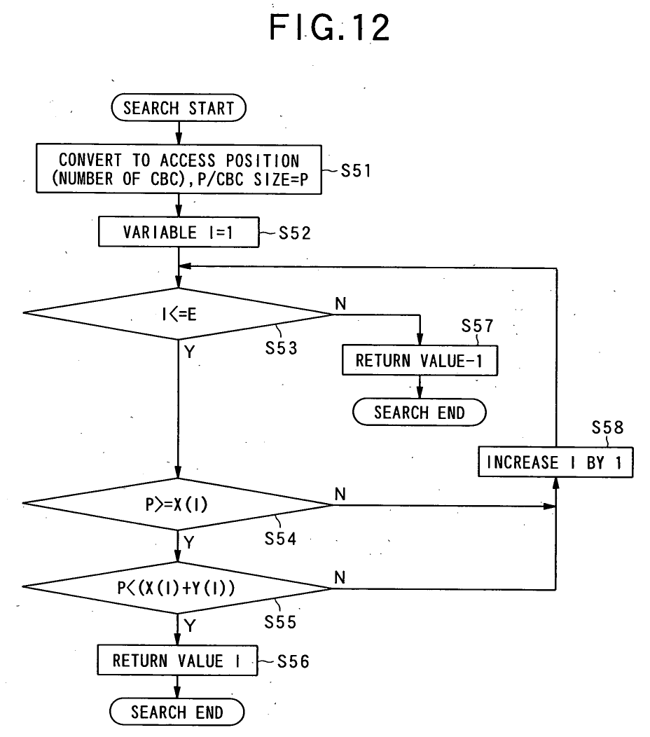

Next, the applicable-range-search process of step S44 will be explained using FIG. 12. The applicable-range-search process is a routine that calculates the access position (number of CBC) in the AV stream information 3, and searches for which key is currently necessary.

First, in step S51, after dividing the access position (number of bytes) in the AV stream information 3 by the amount of CBC block information and finding the current access position (number of CBC) p, the CPU sets parameter i to ‘1’ (step S52). Here, in FIG. 12, parameter i is a parameter that indicates the applicable range number for CBC conversion.

Next, in step S53, the CPU determines whether or not the parameter i is less than the applicable number E in the encoding information 4, and when the parameter i is less than the applicable number E (step S53: YES), then in step S54 the CPU determines whether the access position (number of CBC) p is the ith applicable range x(i) or greater in the CBC block conversion, and when it is the applicable range x(i) or greater (step S54: YES), then in step S55 it determines whether or not that access position (CBC number) p is less than [applicable range x(i)+applicable size y(i)], and when it is less than [applicable range x(i)+applicable size y(i)] (steps S55: YES), then in step S56 the CPU sets the return value when returning to the main routine to ‘i’ and ends the search process.

On the other hand, in step S53, when the applicable number E is greater than the parameter i (step S53: NO), then in step S57 the CPU decrements the return value by ‘1’ and ends the search process.

Also, in step S54, when the applicable range x(i) is outside the access position (CBC number) p (step S53: NO), and in step S55 when [applicable range x(i)+applicable size y(i)] is outside the access position (CBC number) p (step S55: NO), then in step S58 the CPU increments parameter i and returns to step S53.

(III-C) Special Reproduction Process

(C-I) First Special Reproduction Process

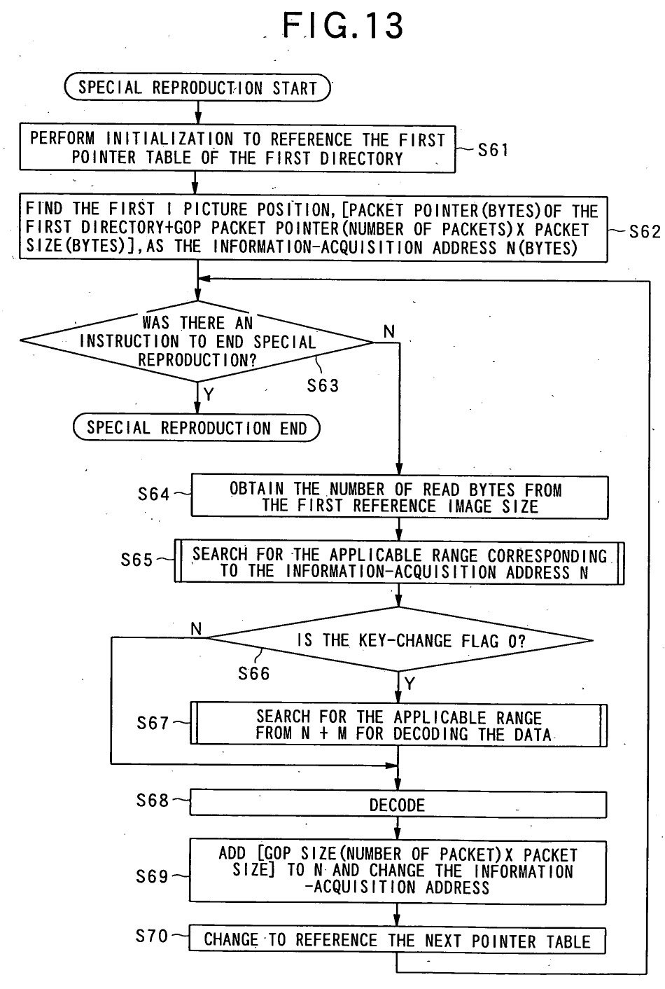

Next, special reproduction processing by the CPU (not shown in the figure) other than the normal reproduction will be explained using FIG. 13.

The special reproduction process shown in FIG. 13 is a special reproduction routine such as fast-forward reproduction or a search process that operates while referencing the key-change flag 11.

First, in step S61, initialization is performed so that the first pointer table in the first directory is referenced.

In step S62, the position of the first I picture, [packet pointer (bytes) of the first directory+GOP packet pointer (number of packets)×packet size (bytes)], is found as the information-acquisition address N (bytes).

In step S63, the CPU determines whether or not there was an instruction to end special reproduction, and when there was an instruction to end special reproduction (step S63: YES), the CPU ends the special reproduction process. However, when there was no instruction to end special reproduction (step S63: NO), the CPU advances to step S64 and acquires the number of read bytes from the first-reference-image size 10, after which it searches for the applicable range for the key K corresponding to the information-acquisition address N (step S65).

In step S66, the CPU (not shown in the figures) determines whether or not the key-change flag 11 is ‘0’, and when the key-change flag 11 is not ‘0’ (step S66: YES), it searches the applicable range of the key K for decoding the data at the position [information-acquisition address N+number of read bytes M] and decodes the data (steps S67, S68). When the key-change flag 11 is ‘0’ (step S66: NO), the CPU advances directly to step S68 and decodes the data.

In step S69, after adding [GOP size (number of packet)×packet size] to the information-acquisition address N to change the information-acquisition address N, the CPU changes to reference the next pointer table 8 (step S70).

After this, the CPU repeats the process from step S64 to step S70 until there is an instruction in step S63 to end special reproduction.

(C-2) Second Special Reproduction Process

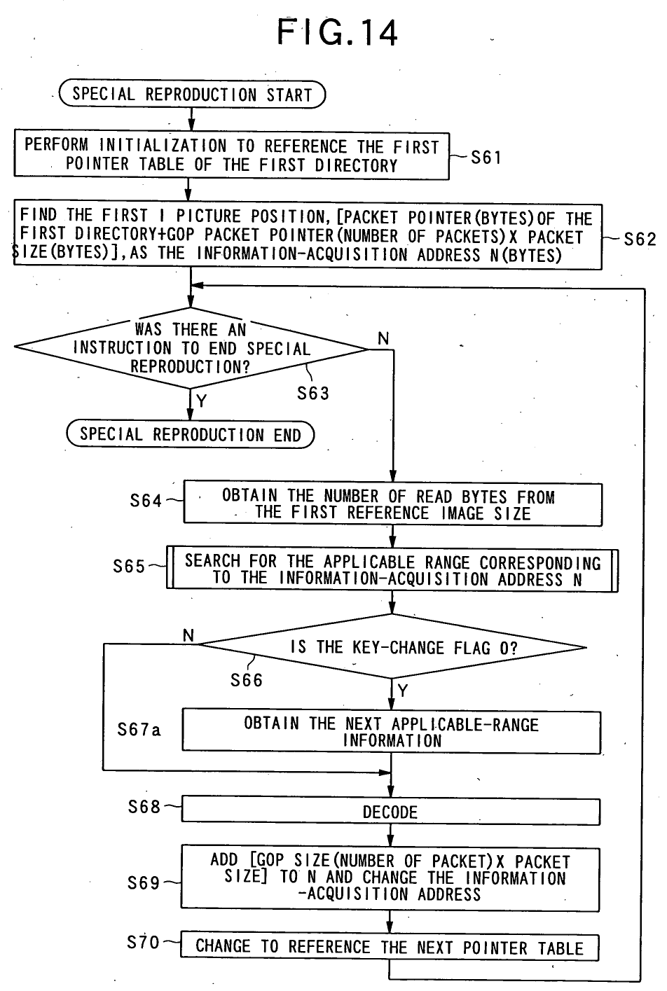

Next, a second special reproduction process by the CPU (not shown in the figure) will be explained using FIG. 14.

The second special reproduction process shown in FIG. 14 is a special reproduction routine that performs optimization of applicable-range information 12, omitting the search routine. Also, the parts of the process that are the same as the first special reproduction process shown in FIG. 13 will be given the same step numbers and an explanation of those steps will be omitted.

The second special reproduction process shown in FIG. 14 is such that in step S66, the CPU determines whether the change-key flag 11 is ‘0’, and when the key-change flag is not ‘0’ (step S66: YES), then in step S67a the CPU obtains the next applicable-range information 12.

Here, assuming that the applicable-range information 12 is arranged in order of access, and that there are no spaces in the applicable range information 12, then as in the special reproduction process shown in FIG. 13, the applicable range search from [information-acquisition address N+number of read bytes M] is omitted, and it is possible to access the next applicable-range information 12 following the currently accessed applicable-range information 12.

(IV) Another Embodiment of the Key-Change Flag

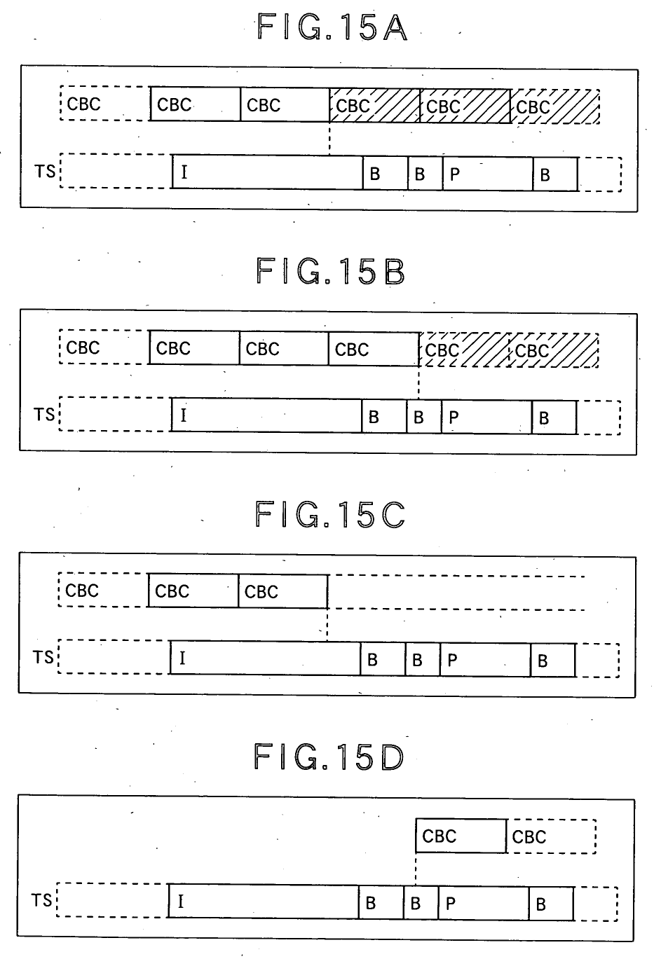

Next, FIGS. 15A to 15D will be used to explain another embodiment of the key-change flag 11. FIGS. 15A to 15D are drawings showing the expansion of the key-change flag 11. In FIGS. 15A and 15B, the hatched area shows that the key K has been changed.

In the embodiment described above, the key-change flag 11 was explained as being 1 byte, however, instead of this, the key-change flag can be expanded such that the first four bits of information indicate whether or not the key K has changed in an application GOP, or the last four bits of information can indicate whether or not the key K has changed while decoding an I picture.

In this case, the first four bits of information are defined such that the value ‘0000b’ (where b is a binary number) indicates that it is not necessary to change the key K when reproducing the corresponding application GOP, the value ‘0001b’ indicates that it is necessary to change the key while reproducing the corresponding application GOP, the value ‘0010b’ indicates that the end point for the AV stream information 3 occurs while reproducing the corresponding application GOP, and the value ‘0011b’ indicates that the start point for the AV stream information 3 occurs while reproducing the corresponding application GOP.

On the other hand, the last four bits of information are defined such that the value ‘0000b’ indicates that it is not necessary to change the key K for reading the corresponding I picture, the value ‘0001b’ indicates that it is necessary to change the key K for reading the corresponding I picture, the value ‘0010b’ indicates that the end point for the AV stream information 3 occurs in the middle of the corresponding I picture, and the value ‘0011b’ indicates that the start point for the AV stream information 3 occurs in the middle of the corresponding I picture.

By using a key-change flag that is defined in the way described above, then as shown in FIG. 15A for example, when there is a key K change position in the middle of an I picture when in the middle of an application GOP, the value of the key-change flag could be expressed as ‘0001b-001b’.

Moreover, as shown in FIG. 15B, when there is a key change position in the middle of an application GOP, the value of the key-change flag can be expressed as ‘0001b-0000b’.

Furthermore, as shown in FIG. 15C, when the application GOP is not encoded from the middle of an I picture when in the middle of an application GOP, the value of the key-change flag can be expressed as ‘0010b-0010b’.

Finally, as shown in FIG. 15D, when the application GOP is encoded starting in the middle of the application GOP however the I picture is not encoded, the value of the key-change flag can be expressed as ‘0011b-0000b’.

In this way, as shown in FIGS. 15A to 15D, it is possible to use a key-change flag to indicate a key change position not only for an I picture but also for a key change position that occurs in the middle of an application GOP.

As was explained above, recorded on the HD 1 of this embodiment is AV stream information 3, which is a transport stream comprising an application GOP according to the MPEG2 standards that is encoded and obtained as encoded information by changing the encoding key at the boundaries between CBC blocks that are different than that application GOP, and a key-change flag 11, which contains key-change information that indicates whether or not a plurality of encoding keys is necessary for decoding an I picture contained in an application GOP of the aforementioned encoded information, so it is not necessary to continuously calculate the applicable point at which the key K changes, making it possible to execute processing smoothly, as well as making it possible to reduce the hardware load and the capacity of the memory 26.

Moreover, there is a key-change flag 11 located in each application GOP, so it is not necessary to continuously calculate the applicable point when the key K changes, making it possible to execute processing smoothly, as well as making it possible to reduce the hardware load and the capacity of the memory 26.

Furthermore, an I picture is decoded as still-image information, so it is not necessary to continuously calculate the applicable point when the key K changes, making it possible to execute processing smoothly, as well as making it possible to reduce the hardware load and the capacity of the memory 26.

Also, the application GOP comprises a sequence header for the MPEG2-standard transport stream, and the GOP that is sent after that sequence header, so it is not necessary to continuously calculate the applicable point when the key K changes, making it possible to execute processing smoothly, as well as making it possible to reduce the hardware load and the capacity of the memory 26.

The information-recording apparatus 20 of this embodiment comprises: a CPU 25 that generates encoded information for an MPEG2-standard transport stream comprising application GOP in which the encoding key changes at the boundary of a CBC block that is different than the application GOP, and a CPU 25 that records key-change information that indicates whether or not a plurality of encoding keys is necessary for decoding an I picture contained in the application GOP in the encoded information, so it is not necessary to continuously calculate the applicable point when the key K changes, making it possible to execute processing smoothly, as well as making it possible to reduce the hardware load and the capacity of the memory 26.

Moreover, there is a key-change flag 11 for each application GOP, so it is not necessary to continuously calculate the applicable point when the key K changes, making it possible to execute processing smoothly, as well as making it possible to reduce the hardware load and the capacity of the memory 26.

Furthermore, the I picture is decoded as still-image information, so it is not necessary to continuously calculate the applicable point when the key K changes, making it possible to execute processing smoothly, as well as making it possible to reduce the hardware load and the capacity of the memory 26.

Also, the application GOP comprises a sequence header for the MPEG2-standard transport stream, and the GOP that is sent after that sequence header, so it is not necessary to continuously calculate the applicable point when the key K changes, making it possible to execute processing smoothly, as well as making it possible to reduce the hardware load and the capacity of the memory 26.

Furthermore, the information-reproduction apparatus 40 of this embodiment comprises: a reading unit 43 that detects and reads encoded information from the HD 1, a decoding unit 42 that decodes the encoded information based on detected key-change information, and a reading unit 43 that reproduces the decoded encoded information, so it is not necessary to continuously calculate the applicable point when the key K changes, making it possible to execute processing smoothly, as well as making it possible to reduce the hardware load.

Also, there is a key-change flag 11 for each application GOP, so it is not necessary to continuously calculate the applicable point when the key K changes, making it possible to execute processing smoothly, as well as making it possible to reduce the hardware load and the capacity of the memory 26.

Furthermore, the I picture is decoded as still-image information, so it is not necessary to continuously calculate the applicable point when the key K changes, making it possible to execute processing smoothly, as well as making it possible to reduce the hardware load and the capacity of the memory 26.

Also, the application GOP comprises a sequence header for the MPEG2-standard transport stream, and the GOP that is sent after that sequence header, so it is not necessary to continuously calculate the applicable point when the key K changes, making it possible to execute processing smoothly, as well as making it possible to reduce the hardware load and the capacity of the memory 26.

This invention is not limited to the embodiments described above, and it is possible to make various changes.

For example, in the embodiments described above, a signal such as a BS digital broadcast was received and a video signal was obtained, however, besides this, it is also possible to acquire a video signal from an analog ground TV broadcast, or from a server VOD (Video On Demand) by way of a dedicated line such as the Internet.

Also, the embodiments described above were explained for the case of using an HD 1 as the recording medium, however, besides this, it is possible to use various other recording media such as a rewritable DVD or flash memory.

Furthermore, by recording programs corresponding to the flowcharts shown in FIG. 5, FIG. 6, FIG. 9 and FIG. 11 thru FIG. 14 on an information-recording medium such as a flexible disk or HD, or by acquiring and recording those programs over a network such as the Internet, and then reading and executing these by an general-purpose microcomputer, it is possible to make that microcomputer function as the CPU 25 of the embodiments.

1. An information-recording medium comprising:
an encoded-information-recording area in which encoded information, which is obtained by encoding recording information containing at least one unit of image information while changing the encoding key at the boundary between the image-information unit and a different encoding unit, is recorded; and
a key-change-information-recording area in which key-change information, which indicates whether or not a plurality of encoding keys is necessary for encoding still-image information contained in said image-information unit in said encoded information, is recorded.

2. The information-recording medium according to claim 1, wherein
there is a said key-change-information-recording area for each said image unit.

3. The information-recording medium according to claim 1, wherein
said still-image information is encoded image information for a frame.

4. The information-recording medium according to claim 1, wherein
said image-information unit comprises an encoded-image-information group that contains at least said encoded-information for a frame.

5. The information-recording medium according to claim 1, wherein
said image-information unit comprises a MPEG (Moving Picture Experts Group)-2TS (Transport Stream) sequence header, and the GOP (Group of Pictures) that is sent after said sequence header.

6. An information-recording apparatus comprising:
a first generation device which generates encoded information, which is obtained by encoding recording information containing at least one unit of image information while changing the encoding key at the boundary between the image-information unit and a different encoding unit; and
a second generation device which records key-change information, which indicates whether or not a plurality of encoding keys is necessary for encoding still-image information contained in said image-information unit in said encoded information.

7. The information-recording apparatus according to claim 6, wherein
there is a said key-change-information-recording area for each said image unit.

8. The information-recording apparatus according to claim 6, wherein
said still-image information is encoded image information for a frame.

9. The information-recording apparatus according to claim 6, wherein
said image-information unit comprises an encoded-image-information group that contains at least said encoded-information for a frame.

10. The information-recording apparatus according to claim 6, wherein
said image-information unit comprises a MPEG (Moving Picture Experts Group)-2TS (Transport Stream) sequence header, and the GOP (Group of Pictures) that is sent after said sequence header.

11. An information-reproduction apparatus that reproduces said recorded information from said information-recording medium on which an encoded-information-recording area in which encoded information, which is obtained by encoding recording information containing at least one unit of image information while changing the encoding key at the boundary between the image-information unit and a different encoding unit; and a key-change-information-recording area in which key-change information, which indicates whether or not a plurality of encoding keys is necessary for encoding still-image information contained in said image-information unit in said encoded information, are recorded; and comprising:
an encoded-information-detection device which detects said encoded information from said information-recording medium;
a key-change-information-detection device which detects said key-change information from said information-recording medium;
a decoding device which decodes said encoded information based on detected said key-change information; and
a reproduction device which reproduces the decoded said encoded information.

12. The information-reproduction apparatus according to claim 11, wherein
there is a said key-change-information-recording area for each said image unit.

13. The information-reproduction apparatus according to claim 11, wherein
said still-image information is encoded image information for a frame.

14. The information-reproduction apparatus according to claim 11, wherein
said image-information unit comprises an encoded-image-information group that contains at least said encoded-information for a frame.

15. The information-reproduction apparatus according to claim 11, wherein
said image-information unit comprises a MPEG (Moving Picture Experts Group)-2TS (Transport Stream) sequence header, and the GOP (Group of Pictures) that is sent after said sequence header.

16. The information-reproduction apparatus according to claim 11, wherein
said decoding device comprises a detection device which detects the necessary encoding keys for decoding still-image information when the detected said key-change information indicates that two or more said encoding keys are necessary in the process of decoding said encoded still-image information.

17. An information-recording method comprising:
a first generation process of generating encoded information by encoding recording information containing at least one unit of image information, while changing the encoding key at the boundary between the image-information unit and a different encoding unit; and
a second generation process of generating key-change information, which indicates whether or not a plurality of encoding keys is necessary for encoding still-image information contained in said image-information unit in said encoded information.

18. An information-reproduction method that reproduces said recorded information from said information-recording medium on which an encoded-information-recording area in which encoded information, which is obtained by encoding recording information containing at least one unit of image information while changing the encoding key at the boundary between the image-information unit and a different encoding unit; and a key-change-information-recording area in which key-change information, which indicates whether or not a plurality of encoding keys is necessary for encoding still-image information contained in said image-information unit in said encoded information, are recorded; and comprising:
an encoded-information-detection process of detecting said encoded information from said information-recording medium;
a key-change-information-detection process of detecting said key-change information from said information-recording medium;
a decoding process of decoding said encoded information based on detected said key-change information; and
a reproduction process of reproducing the decoded said encoded information.

19. An information-recording program that makes a recording computer contained in an information-recording apparatus that records recording information containing at lease one unit of image information onto a recording medium function as:
a first generation device which generates encoded information by encoding said recording information while changing the encoding key at the boundary between the image-information unit and a different encoding unit; and
a second generation device which generates key-change information, which indicates whether or not a plurality of encoding keys is necessary for encoding still-image information contained in said image-information unit in said encoded information.

20. An information-reproduction program that makes a reproduction computer contained in an information-reproduction apparatus that reproduces said recorded information from said information-recording medium on which an encoded-information-recording area in which encoded information, which is obtained by encoding recording information containing at least one unit of image information while changing the encoding key at the boundary between the image-information unit and a different encoding unit; and a key-change-information-recording area in which key-change information, which indicates whether or not a plurality of encoding keys is necessary for encoding still-image information contained in said image-information unit in said encoded information, are recorded; function as:
an encoded-information-detection device which detects said encoded information from said information-recording medium;
a key-change-information-detection device which detects said key-change information from said information-recording medium;
a decoding device which decodes said encoded information based on detected said key-change information; and
a reproduction device which reproduces the decoded said encoded information.

21. A program-recording medium on which the information-recording program of claim 19 is recorded such that it can be read by said recording computer.

22. A program-recording medium on which the information-reproduction program of claim 20 is recorded such that it can be read by said reproduction computer.
